(19) United States
(12) Patent Application Publication
(10) Pub. No.: US 2017/0117745 A1
(43) Pub. Date: Apr. 27, 2017

(54) METHOD FOR SUPPLYING POWER AND UNINTERRUPTIBLE POWER SUPPLY EQUIPMENT

(71) Applicants: LITE-ON ELECTRONICS (GUANGZHOU) LIMITED, GUANGZHOU (CN); LITE-ON TECHNOLOGY CORP., TAIPEI (TW)

(72) Inventors: WEI-LIEH LAI, TAIPEI (TW); CHIEH-FU HSIAO, TAIPEI (TW)

(21) Appl. No.: 15/080,868

(22) Filed: Mar. 25, 2016

(30) Foreign Application Priority Data
Oct. 23, 2015 (CN) 201510702842.6

(51) Int. Cl. H02J 9/06

(52) U.S. Cl. CPC H02J 9/061

(57) ABSTRACT

A method for supplying power is implemented by an uninterruptible power supply (UPS) equipment that includes a bus, a power supply and a UPS device. The method includes the steps of: determining whether a supply power outputted by the power supply to a load is in an abnormal condition; boosting a voltage level of a backup power outputted by the UPS device to be greater than the voltage level of the supply power in a normal condition so as to output a backup current to the load; decreasing the voltage level of the backup power gradually; and determining whether the supply power is still in the abnormal condition according to a current value of the backup current during decrease of the voltage level of the backup power.

### CROSS-REFERENCE TO RELATED APPLICATION

This application claims priority of Chinese Application No. 201510702842.6, filed on Oct. 23, 2015.

### FIELD

The disclosure relates to a method for supplying power, and more particularly to a method for supplying power and an uninterruptible power supply equipment.

### BACKGROUND

Referring to FIG. 1, a conventional uninterruptible power supply (UPS) equipment 10 includes a UPS device 11, a power supply 13 and a bus 14. The power supply 13 is electrically connected to a mains electricity source 12 and a load 100. The UPS device 11 is electrically connected to the mains electricity source 12, the power supply 13 and the load 100 for receiving power condition signals therefrom. The power condition signals represent power conditions of the mains electricity source 12, the power supply 13 and the load 100. The UPS device 11 has a battery charged by an alternating-current (AC) voltage from the mains electricity source 12, and detects the condition of electric power supplied to the load 100 according to the power condition signals or by communicating with the load 100. The battery supplies a backup power via the bus 14 to the load 100 when the mains electricity source 12 is out of order.

However, when the power condition signals are interrupted or communication outage occurs between the UPS device 11 and the load 100, the UPS device 11 cannot correctly detect the condition of the electric power supplied to the load 100. As a result, the UPS device 11 may not properly supply the backup power to the load 100. For example, the mains electricity source 12 is out of order, and the UPS device 11 does not supply the backup power to the load 100. In another case, the mains electricity source 12 works normally, and the UPS device 11 keeps supplying the backup power to the load 100 till the battery runs out; thus, the battery of the UPS device 11 may not be able to supply the backup power to the load 100 when the mains electricity source 12 is out of order.

### SUMMARY

Therefore, an object of the disclosure is to provide a method for supplying power that can alleviate at least one of the drawbacks of the prior art.

According to one aspect of the disclosure, a method for supplying power to be implemented by an uninterruptible power supply (UPS) equipment is provided. The UPS equipment includes a bus electrically connected to a load, a power supply electrically connected to the bus for outputting a supply power to the load through the bus, and a UPS device electrically connected to the bus. The method includes the steps of: (A) determining, by the UPS device, whether the supply power is in an abnormal condition according to a voltage level of the supply power at the bus; (B) boosting, by the UPS device, a voltage level of the backup power greater than the voltage level of the supply power not in the abnormal condition so as to output a backup current to the load when it is determined in step (A) that the supply power is in the abnormal condition; (C) decreasing, by the UPS device, the voltage level of the backup power gradually; and (D) determining, by the UPS device, whether the supply power is still in the abnormal condition according to a current value of the backup current during decrease of the voltage level of the backup power.

According to another aspect of the disclosure, an uninterruptible power supply equipment includes a bus, a power supply, and an uninterruptible power supply (UPS) device. The bus is configured to be connected to a load. The power supply is electrically connected to the bus, and is configured to receive the mains electricity, to transfer the mains electricity into a supply power, and to output the supply power to the load through the bus. The UPS device is electrically connected to the bus, is configured to output a backup power to the load through the bus. The UPS device is operable to determine whether the supply power is in an abnormal condition according to a voltage level of the supply power at the bus, to boost a voltage level of the backup power greater than the voltage level of the supply power not in the abnormal condition so as to output a backup current to the load when it is determined that the supply power is in the abnormal condition, to decrease the voltage level of the backup power gradually, and to determine whether the supply power is still in the abnormal condition according to a current value of the backup current during decrease of the voltage level of the backup power.

### BRIEF DESCRIPTION OF THE DRAWINGS

Other features and advantages of the disclosure will become apparent in the following detailed description of the embodiment with reference to the accompanying drawings, of which:

FIG. 1 is a block diagram illustrating a conventional uninterruptible power supply equipment;

FIG. 2 is a block diagram illustrating an embodiment of an uninterruptible power supply equipment according to the disclosure;

FIG. 3 is a flowchart illustrating an embodiment of a method for supplying power according to the disclosure; and

FIG. 4 is a timing diagram illustrating exemplary operation of the uninterruptible power supply equipment according to the disclosure.

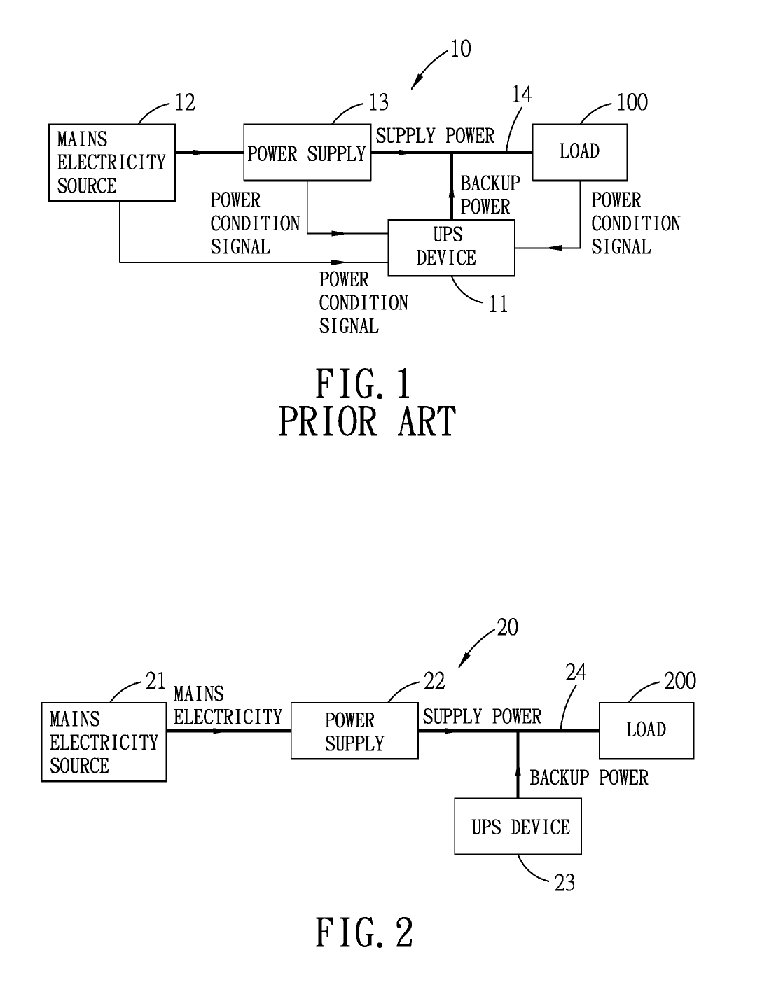

### DETAILED DESCRIPTION

Referring to FIG. 2, an embodiment of an uninterruptible power supply (UPS) equipment 20 according to this disclosure includes at least one power supply 22, at least one UPS device 23 and a bus 24.

The bus 24 is electrically connected to the power supply 22, the UPS device 23 and a load 200. The load 200 is supplied with power via the bus 24 from one of the power supply 22 and the UPS device 23. In this embodiment, the load 200 is a server cabinet.

In this embodiment, the UPS equipment 20 only includes one power supply 22 and one UPS device 23. However, the scope of the disclosure is not limited to this embodiment, and the UPS equipment 20 may be applied in a power supply system having a parallel connection of direct-current (DC) power sources and may include a plurality of the power supplies 22 and a plurality of the UPS devices 23 according to the disclosure. The power supply 22 receives the mains electricity in a form of an alternating-current (AC) voltage from a mains electricity source 21, and transfers the mains electricity into a DC voltage as a supply power. The UPS device 23 is configured to generate a backup power. In this embodiment, the UPS device 23 is a DC UPS device, and has a battery capable of supplying the backup power. The backup power is a DC voltage.

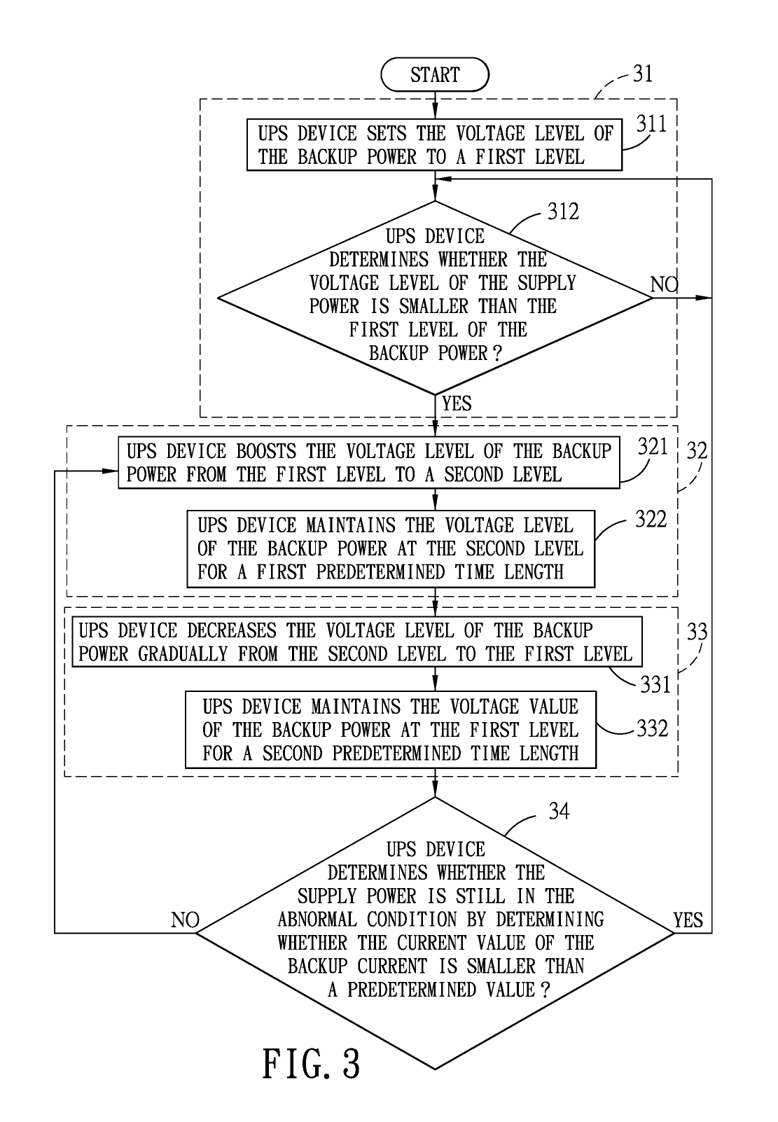

Referring to FIGS. 2 and 3, a method for supplying power implemented by the UPS equipment 20 is described below.

In step 31, the UPS device 23 determines whether the supply power from the power supply 22 is in an abnormal condition according to a voltage level of the supply power at the bus 24. In this embodiment, the voltage value of the supply power from the power supply 22 is 12.5 V when it is in a normal condition (i.e., not in the abnormal condition). In detail, step 31 includes sub-step 311 and sub-step 312. In sub-step 311, the UPS device 23 sets the voltage level of the backup power to a first level that is smaller than the voltage level of the supply power in the normal condition. In this embodiment, the first level is 12.25 V. In sub-step 312, the UPS device 23 determines whether the voltage level of the supply power is smaller than the first level of the backup power so as to determine whether the supply power from the power supply 22 is in the abnormal condition. The flow goes to step 32 when it is determined that the voltage level of the supply power is smaller than the first level of the backup power, and sub-step 312 is repeated when otherwise.

In step 32, the UPS device 23 boosts a voltage level of the backup power to be greater than the voltage level of the supply power in the normal condition so as to output a backup current to the load 200 through the bus 24 when it is determined in step 31 that the supply power is in the abnormal condition (i.e., the voltage level of the supply power is smaller than the first level of the backup power). It should be noted that the UPS device 23 automatically outputs the backup power to the load 200 since the voltage value of the backup power is greater than the voltage value of the supply power on the bus 24. In detail, step 32 includes sub-step 321 and sub-step 322. In sub-step 321, the UPS device 23 boosts the voltage level of the backup power from the first level to a second level that is greater than the voltage level of the supply power in the normal condition. In this embodiment, the second level is 12.6 V. In sub-step 322, the UPS device 23 maintains the voltage level of the backup power at the second level for a first predetermined time length, and continuously outputs the backup power to the load 200. The flow goes to step 33 after the first predetermined time length has elapsed. It should be noted that, by boosting the voltage level of the backup power, stability of the backup power supplied to the load 200 is relatively greater, and the voltage level the backup power approximates to a nominal value of the voltage level of the supply power.

In step 33, the UPS device 23 decreases the voltage level of the backup power gradually. In detail, step 33 includes sub-step 331 and sub-step 332. In sub-step 331, the UPS device 23 decreases the voltage level of the backup power gradually from the second level to the first level. Then, in sub-step 332, the UPS device 23 maintains the voltage value of the backup power at the first level for a second predetermined time length.

In step 34, the UPS device 23 determines whether the supply power is still in the abnormal condition according to a current value of the backup current during decrease of the voltage level of the backup power. In detail, the UPS device 23 determines whether the supply power is still in the abnormal condition by determining whether the current value of the backup current is smaller than a predetermined value. The UPS device 23 determines that the supply power has recovered from the abnormal condition to the normal condition when the current value of the backup current is smaller than the predetermined value, and the flow goes back to sub-step 312. On the other hand, the UPS device 23 determines that the supply power is still in the abnormal condition when the current value of the backup current is not smaller than the predetermined value, and the flow goes back to sub-step 321. In this embodiment, the predetermined value is 1 A.

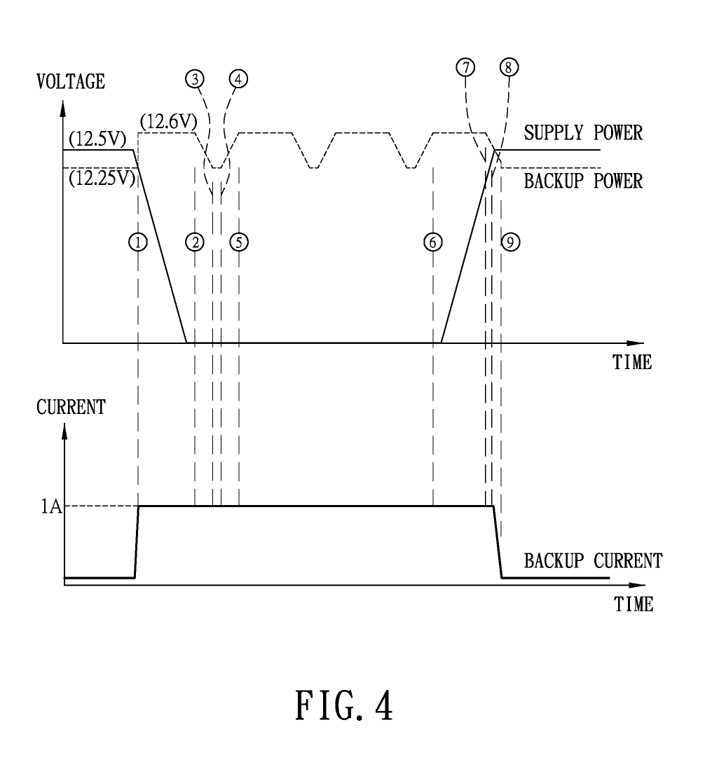

Further referring to FIG. 4, normally, the power supply 22 receives the mains electricity from the mains electricity source 21 and outputs the supply power of 12.5 V to the load 200 through the bus 24, and the UPS device 23 sets the voltage level of the backup power to 12.25 V (i.e., the first level) (sub-step 311). Since the power supply 22 outputs the supply power to the load 200, the backup current from the UPS device 23 is smaller than 1 A.

When the mains electricity source 21 is interrupted and cannot provide the mains electricity to the power supply 22 at time point (1), the supply power becomes being in the abnormal condition. As a result, the voltage value of the supply power is reduced to being lower than 12.25 V (i.e., the first level), and the UPS device 23 detects that the voltage level of the supply power at the bus 24 is smaller than 12.25 V and determines that the supply power is in the abnormal condition (sub-step 312). After determining that the supply power is in the abnormal condition, the UPS device 23 boosts the voltage value of the backup power from 12.25 V to 12.6 V (i.e., the second level) and supplies the load 200 with the backup power via the bus 24 (sub-step 321). The UPS device 23 maintains the voltage level of the backup power at 12.6 V for the first predetermined time length (i.e., from time point (1) to time point (2)) (sub-step 322).

The UPS device 23 starts to gradually decrease the voltage value of the backup power from 12.6 V at time point (2) to 12.25 V at time point (3) (sub-step 331), and maintains the voltage value of the backup power at 12.25 V from time point (3) to time point (4) (i.e., the second predetermined time length) (sub-step 332). From time point (2) to time point (4), the UPS device 23 determines whether the current value of the backup current is smaller than 1 A (i.e., the predetermined value) (step 34).

When the current value of the backup current is not smaller than 1 A in the duration from time point (2) to time point (4), it means that the mains electricity source 21 is still interrupted and that the supply power is still in the abnormal condition, and the UPS device 23 starts to gradually boost again the voltage value of the backup power from 12.25 V at time point (4) to 12.6 V at time point (5) (sub-step 321). The steps of boosting and decreasing the voltage value of the backup power by the UPS device 23 (steps 32-34) will be repeated as long as the UPS device 23 continuously determines that the current value of the backup power is not smaller than 1 A.

At time point (6), the supply power recovers from the abnormal condition, and the voltage value of the supply power starts to increase gradually. Further, the UPS device 23 starts to gradually decrease the voltage value of the backup power at time point (7), and the voltage value of the supply power increases to 12.5 V, greater than the voltage value of the backup power, at time point (8), which means that the power supply 22 and the mains electricity source 21 work normally. The load 200 is then supplied with power by the power supply 22 at time point (8) because the voltage value of the supply power is greater than the voltage value of the backup power. At time point (9), the backup current decreases and is smaller than 1 A, and the voltage value of the backup power is set to 12.25 V. Accordingly, the UPS device 23 determines that the supply power is in the normal condition.

In sum, the method for supplying power has the following advantages. First, the UPS device 23 determines a condition of the supply power by directly detecting the voltage value of the supply power at the bus 24 without receiving power condition signals from the mains electricity source 21, the power supply 23 and the load 200. Therefore, complexity of wiring and communication of the UPS equipment 20 and the load 200 (e.g., the server cabinet) can be reduced. Further, the UPS device 23 boosts the voltage value of the backup power to be greater than the voltage value of the supply power in the normal condition when the UPS device 23 provides the backup power to the load 200, increasing the stability of the UPS equipment 20.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for supplying power to be implemented by an uninterruptible power supply (UPS) equipment that includes a bus electrically connected to a load, a power supply electrically connected to the bus for outputting a supply power to the load through the bus, and a UPS device electrically connected to the bus, the method comprising the steps of:
(A) determining, by the UPS device, whether the supply power is in an abnormal condition according to a voltage level of the supply power at the bus;
(B) boosting, by the UPS device, a voltage level of the backup power to be greater than the voltage level of the supply power not in the abnormal condition so as to output a backup current to the load when it is determined in step (A) that the supply power is in the abnormal condition;
(C) decreasing, by the UPS device, the voltage level of the backup power gradually; and
(D) determining, by the UPS device, whether the supply power is still in the abnormal condition according to a current value of the backup current during decrease of the voltage level of the backup power.

2. The method as claimed in claim 1, wherein step (A) includes the sub-steps of:
(A1) setting the voltage level of the backup power to a first level that is smaller than the voltage level of the supply power not in the abnormal condition; and
(A2) determining whether the voltage level of the supply power is smaller than the first level of the backup power so as to determine whether the supply power is in the abnormal condition.

3. The method as claimed in claim 2, wherein the UPS device determines in sub-step (A2) that the supply power is in the abnormal condition when determining that the voltage level of the supply power is smaller than the first level of the backup power.

4. The method as claimed in claim 2, wherein step (B) includes the sub-step of:
(B1) boosting the voltage level of the backup power from the first level to a second level that is greater than the voltage level of the supply power not in the abnormal condition.

5. The method as claimed in claim 4, wherein step (B) further includes the sub-step of:
(B2) maintaining the voltage level of the backup power at the second level for a first predetermined time length.

6. The method as claimed in claim 4, wherein, in step (D), the UPS device determines whether the current value of the backup current is smaller than a predetermined value, determines that the supply power has recovered from the abnormal condition when the current value of the backup current is smaller than the predetermined value, and determines that the supply power is still in the abnormal condition when the current value of the backup current is not smaller than the predetermined value.

7. The method as claimed in claim 6, further comprising, after step (D), the steps of:
repeating step (A) when it is determined that the supply power has recovered from the abnormal condition; and
repeating step (B1) when it is determined that the supply power is still in the abnormal condition.

8. The method as claimed in claim 4, wherein step (C) includes the sub-step of:
(C1) decreasing the voltage level of the backup power gradually from the second level to the first level.

9. The method as claimed in claim 8, wherein step (C) further includes the sub-step of:
(C2) maintaining the voltage value of the backup power at the first level for a second predetermined time length.

10. An uninterruptible power supply equipment comprising:
a bus configured to be connected to a load;
a power supply electrically connected to said bus, and configured to receive the mains electricity, to transfer the mains electricity into a supply power, and to output the supply power to the load through said bus; and
an uninterruptible power supply (UPS) device electrically connected to said bus, configured to output a backup power to the load through said bus, and operable to
determine whether the supply power is in an abnormal condition according to a voltage level of the supply power at said bus,
boost a voltage level of the backup power to be greater than the voltage level of the supply power not in the abnormal condition so as to output a backup current to the load when it is determined that the supply power is in the abnormal condition,
decrease the voltage level of the backup power gradually, and
determine whether the supply power is still in the abnormal condition according to a current value of the backup current during decrease of the voltage level of the backup power.

11. The uninterruptible power supply equipment as claimed in claim 10, wherein said UPS device is further operable to set the voltage level of the backup power to a first level that is smaller than the voltage of the supply power not in the abnormal condition, and to determine whether the voltage level of the supply power is smaller than the first level of the backup power so as to determine whether the supply power is in the abnormal condition.

12. The uninterruptible power supply equipment as claimed in claim 11, wherein said UPS device determines that the supply power is in the abnormal condition when determining that the voltage level of the supply power is smaller than the first level of the backup power.

13. The uninterruptible power supply equipment as claimed in claim 11, wherein said UPS device is operable to boost the voltage level of the backup power from the first level to a second level that is greater than the voltage level of the supply power not in the abnormal condition when it is determined that the supply power is in the abnormal condition.

14. The uninterruptible power supply equipment as claimed in claim 13, wherein said UPS device is further operable to maintain the voltage level of the backup power at the second level for a first predetermined time length.

15. The uninterruptible power supply equipment as claimed in claim 13, wherein said UPS device is further operable to determine whether the current value of the backup power is smaller than a predetermined value, to determine that the supply power recovers from the abnormal condition when the current value of the backup power is smaller than the predetermined value, and to determine that the supply power is still in the abnormal condition when the current value of the backup power is not smaller than the predetermined value.

16. The uninterruptible power supply equipment as claimed in claim 15, wherein said UPS device is further operable to set the voltage level of the backup power to the first level when it is determined that the supply power has recovered from the abnormal condition, and to boost the voltage level of the backup power from the first level to the second level when it is determined that the supply power is still in the abnormal condition.
